(19) United States
(12) Patent Application Publication
(10) Pub. No.: US 2026/0152982 A1
(43) Pub. Date: Jun. 4, 2026

(54) DEVICE FOR SECURELY LOCKING AN ADJUSTMENT SYSTEM OF A FASTENER

(71) Applicant: LATECOERE, Toulouse (FR)

(72) Inventors: Sébastien DEVILLEZ, SAINT JEAN (FR); Martin Gildas, LUnion (FR)

(73) Assignee: LATECOERE, Toulouse (FR)

(21) Appl. No.: 19/123,447

(22) PCT Filed: Oct. 5, 2023
(86) PCT No.: PCT/EP2023/077516

§ 371 Date: Apr. 23, 2025

(30) Foreign Application Priority Data
Oct. 25, 2022 (FR) FR2211097

(51) Int. Cl. E05D 7/04

(52) U.S. Cl. CPC E05D 7/04; E05Y 2600/12; E05Y 2600/45; E05Y 2600/632; E05Y 2900/502

(57) ABSTRACT

A device for securely locking an adjustment system (1) of a fastener (2) of an opening panel, this fastener having at least one splined washer (4) translating along a cylindrical body (3a) of an adjustment sleeve (3) and movable between a secure locking position in which the splined washer (3) is inserted into a counter-spline (5) by the thrust of a compression spring (6) and a released position in which the splined washer (4) is immobilized at a distance d from the counter-spline (5).

### TECHNICAL FIELD

The invention relates to a device intended to block and secure by locking an adjustment system of a fastening clip of an opening panel, as well as to a mechanical system for opening/closing an opening panel equipped with this device. In particular, vehicle openings panels-aircraft, trains, ships-are intended to be attached then positioned using an adjustment device, this adjustment being blocked to maintain the desired positioning.

The invention also relates to a method of installing an opening panel on a frame using such a mechanical opening/closing system.

In the aeronautical field in particular, the doors and hatches of an aircraft are opening panels whose positioning adjustment is carried out to adjust and align the opening panel with the frame-here the fuselage-allowing better aerodynamic performance to be obtained.

### PRIOR ART

Generally speaking, threaded elements allow the installation and attachment of the opening as well as the adjustment of this installation carried out by slight modifications to the positioning of this installation which align the opening frame on the host structure. The locking of these threaded elements is traditionally ensured by locknuts screwed with the nuts onto these elements as described in document WO2022/162090.

Locknuts have the advantage of fitting directly onto threaded elements. The locknuts can however loosen hence the need to use mechanical locking means such as locking wires installed in the thread to mechanically lock the nut. However, installing a locking wire and locking it takes a long time because each locking wire is wound and each nut is drilled to allow the locking wire to pass through. In addition, during maintenance or adjustment modification phases, the locking wire is cut and is therefore not reusable, resulting in wire waste, additional cost of replacing the locking wire and a lengthy replacement procedure. This operation is all the more delicate since in aeronautical applications, the opening panels are often installed in cramped and difficult-to-access spaces. The use of lock nuts is therefore not very suitable for the installation constraints of the opening panels.

U.S. Pat. No. 3,368,602 describes a self-locking screw whose resulting screw-nut assembly is particularly suitable for resisting vibrations. In fact, such vibrations cause micro-displacements of the nut which then separates from the screw and leads to a disassembly of the structure that the screw-nut assembly consolidated. Documents CN105090208 and CN113124038 describe other types of self-locking screws whose nut fits onto a notched washer which thus prevents the nut from unscrewing. However, these self-locking screws have the function of tightening more or less the fixed assembly of two structural elements without loss of the screw and nut elements. When the assembly is less tight, a clearance is created between the screw and the nut and the assembled elements are then mobile in relation to each other: they are therefore not locked or adjusted in relation to each other.

Cotter pins installed in the core of threaded elements are also used as a blocking and locking means. Since these cotter pins are located inside the threaded elements, they can be used in limited spaces. However, this locking system has the disadvantage of significantly limiting the number of adjustment positions so as not to weaken the load resistance of these elements. In addition, inserting the cotter pins requires that the alignment of the parts can be visually checked, which remains difficult to accomplish in a confined space.

There are also devices based on deformed elements (foldable washers) but which limit the possible number of adjustments before replacement.

### PRESENTATION OF THE INVENTION

In order to overcome the drawbacks of the state of the art set out above, the main objective of the invention is to enable rapid and secure locking of a threaded fastener as well as easy installation of this locking means in a constraint environment.

To do this, the invention provides for producing a locking device at the end of a threaded element as mentioned above, while avoiding the need to bore this threaded element, such boring would lead to an increase in its diameter or a deterioration in its opening holding performance.

More specifically, the present invention relates to a secure locking device for an adjustment system for an opening panel attachment. This attachment is connected to a frame by a support and comprises at least one rod, each rod being inserted into an adjustment sleeve and secured to this sleeve by a translational locking means. Each adjustment sleeve comprises:
a cylindrical body with an external thread facing an internal thread of the support, and
an adjustment end whose rotation causes a translation of the adjustment sleeve.

The locking device comprises a grooved washer in translation along each adjustment sleeve.

A return means connected to the adjustment end of the adjustment sleeve keeps the grooved washer in contact with a counter-groove of complementary configuration and integral with the attachment support.

The grooved washer is movable between two positions:
a blocked position in which the grooved washer is engaged in the counter-groove, rotationally fixed relative to the adjustment sleeve and secured by a push from the return means;
a released position in which the grooved washer is immobilized at a distance “d” from the counter-groove, this distance “d” being sufficient to avoid contact between the grooved washer and the counter-groove while allowing rotation of the adjustment sleeve.

Advantageously, the blocking is ensured by the contact between the grooved washer and the counter-groove. This contact is made without tightening, thus eliminating the need for any tightening tools, and blocking can therefore be achieved in small spaces.

In addition, the return means makes it possible to secure the blocking by locking the grooved washer on the counter-groove.

Also advantageously, the secure locking device is made up of simple parts which are installed at the end of the adjustment sleeve: installation is therefore made easier when assembling the fastener. The installation of the locking device and its use are therefore quick while guaranteeing locking quality through the engagement of the grooves.

According to preferred embodiments taken alone or in combination:
the return means is a compression spring resting on the adjustment end of the sleeve;
the grooved washer has a support surface for the compression spring;
the bearing surface of the grooved washer has a traction collar;
the grooved washer has at least one internal protrusion;
the cylindrical body of the adjustment sleeve comprises at least one axial groove in which is inserted an internal protrusion of the grooved washer capable of moving in translation along the cylindrical body;
the cylindrical body of the adjustment sleeve has a circumferential groove positioned at least at the distance “d” from the counter-groove and adapted to receive the internal protrusions of the grooved washer which can then pivot relative to the adjustment sleeve by engaging in the circumferential groove;
the grooved washer and the counter groove are made of metallic material, and
the grooved washer has radial grooves which fit onto the counter groove.

The invention also relates to a attachment comprising adjustment means along two axes perpendicular to each other, each of these adjustment means being equipped with a secure locking device defined above.

Advantageously, this two-axis adjustment attachment allows the attachment to be quickly adjusted in two directions in a small space. The invention also relates to a mechanical system for opening/closing an opening panel comprising an arm connected to a frame by two attachments as defined above.

The subject of the invention also relates to a method of installing an opening panel on a frame using such a mechanical opening/closing system comprising at least one secure adjustment locking device as defined above. The installation takes place in the following steps:
attaching the mechanical opening/closing system of the opening panel on the frame;
initial positioning of the opening panel in the frame;
assembling the opening panel on the mechanical opening/closing system, and adjusting the attachments.

Each adjustment of the attachments takes place according to the following steps:
disengagement of the grooved washer from the counter groove;
holding the grooved washer in the unlocked position;
adjustment of attachment by operating the adjustment end;
release of the grooved washer, and
checking the engagement of the grooved washer in the counter groove.

Advantageously, the adjustment of the attachments is quick and simple to carry out, in particular without the need for tightening tools. In addition, the engagement of the grooved washer in the counter-groove is automatic: if the engagement is not achieved, a slight rotation of the adjustment sleeve allows it to pass through a position where the grooves are facing each other and engage under the effect of the return means.

According to certain preferred forms of implementation, taken alone or in combination:
the step of disengaging the grooved washer from the counter-groove is carried out by a translation of the grooved washer in the axial groove in opposition to the return means;
the step of holding the grooved washer in the released position is carried out by rotating the grooved washer in the circumferential groove of the adjustment sleeve, and
the grooved washer release step is achieved by reverse rotation of the grooved washer in the circumferential groove of the adjustment sleeve.

### PRESENTATION OF THE FIGURES

Other characteristics and advantages of the present invention will emerge from the following reading of a detailed exemplary embodiment without limiting its scope, with reference to the appended figures which represent, respectively:

FIG. 1, an exploded perspective view of all the elements of the attachment;

FIG. 2, an exploded perspective view of adjustment elements of the attachment;

FIG. 3, an exploded view from another perspective of the adjustment elements of the attachment;

FIG. 4, a view of each of the faces of the grooved washer;

FIG. 5, a perspective view of the grooved washer inserted into the sleeve;

FIG. 6a and FIG. 6b, a perspective view and a sectional view of the secure locking device in flight configuration;

FIG. 7a and FIG. 7b, a perspective view and a sectional view of the secure locking device during translation of the grooved washer;

FIG. 8a and FIG. 8b, a perspective view and a sectional view of the secure locking device in adjustment configuration;

FIG. 9, a perspective view of a two-way adjustment fastening clip, and

FIG. 10, a perspective view of a door opening/closing system with two attachments each with two adjustment directions.

### DETAILED DESCRIPTION

In the figures, identical reference signs refer to the same element and to the corresponding passages of the description.

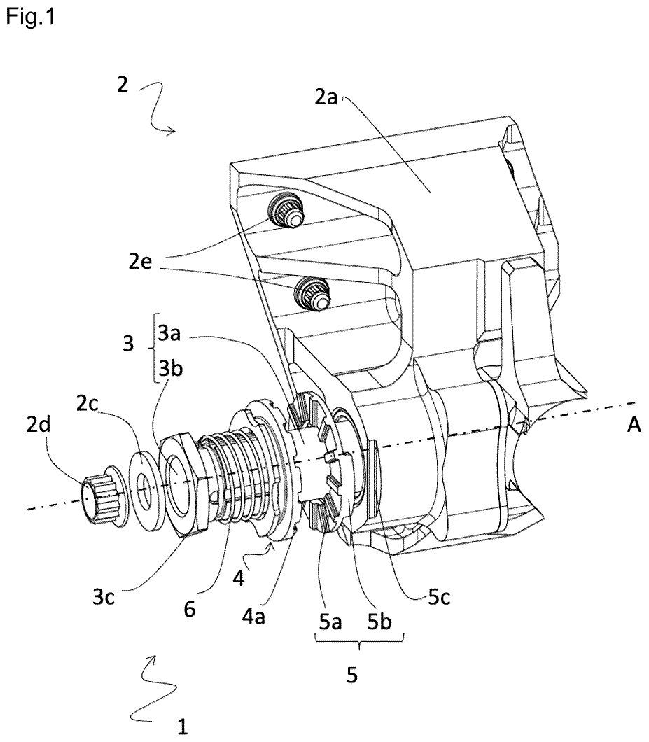

FIG. 1 shows an exploded view of an example according to the invention of a secure locking device 1 of a system for adjusting a door attachment 2.

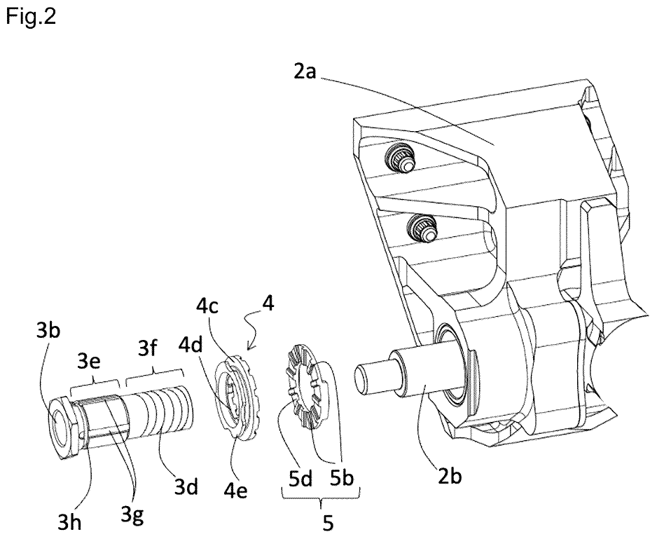

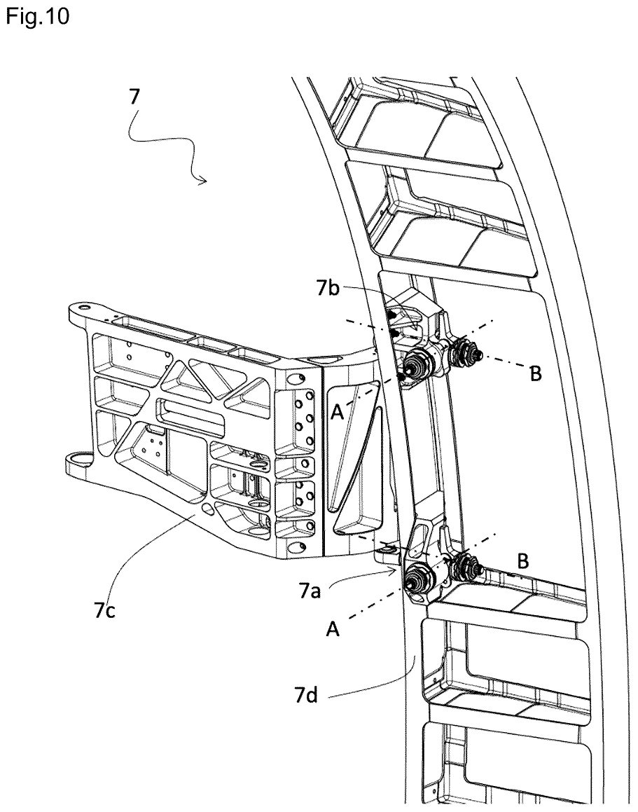

This attachment is connected by screws 2e to a frame 7d (shown in FIG. 10) and comprises a rod 2b (shown in FIG. 2) as well as a support 2a on which the screws 2e are placed. The rod 2b is inserted into the adjustment sleeve 3 along an axis A and secured in translation to this adjustment sleeve 3 by a washer 2c and a tightening nut 2d.

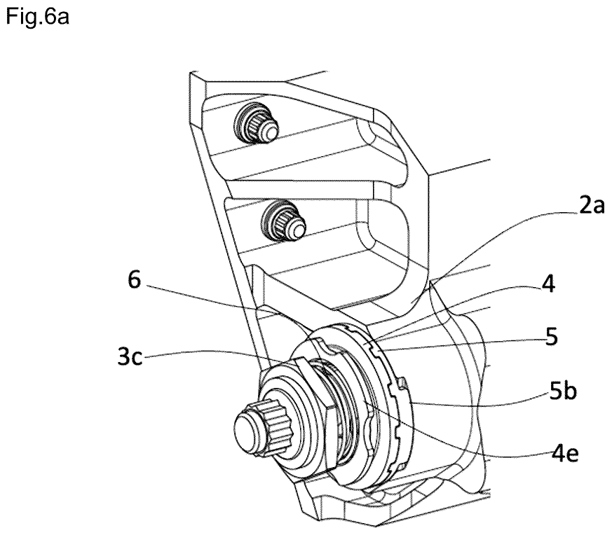

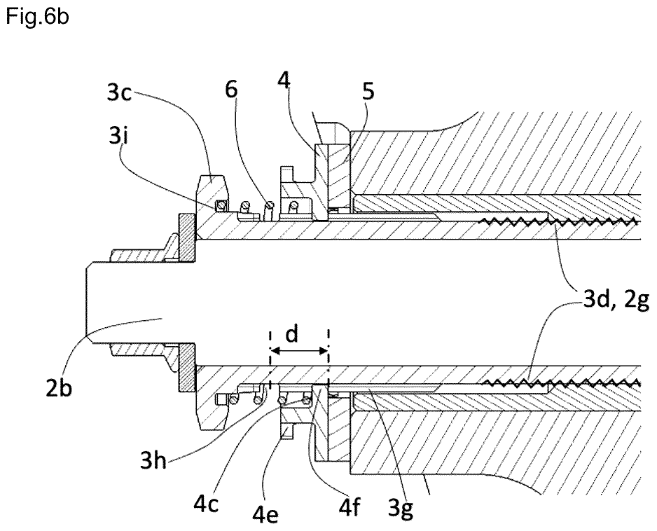

The adjustment sleeve 3 has:
a cylindrical body 3a with an external thread 3d (shown in FIG. 2) facing an internal thread 2g of the support 2a (shown in FIG. 6b), and an adjustment end 3b whose rotation causes the translation of the adjustment sleeve 3.

The adjustment end 3b has a nut-shaped head 3c whose rotation by a conventional adjustable wrench type tool engages the threads of the cylindrical body 3a and the support 2a. This engagement in the helical connection of the threads transforms the rotation of the head 3c into movement of the adjustment sleeve 3 in the support 2a in the direction of the axis A.

In addition, the locking device 1 comprises a grooved washer 4 in translation along the axis A of each adjustment sleeve 3. A spring 6 placed against the adjustment end 3b of the adjustment sleeve 3 then keeps the grooved washer 4 in contact with the counter-groove 5. This counter-groove 5 is adapted to present a geometric configuration—namely radial moldings 5a—complementary to the configuration of the grooved washer 4—formed by radial striations 4a—in order to achieve their interlocking.

The counter-groove 5 is also integral with the support 2. In fact, to maintain the adjustment of the attachment 2, that is to say to maintain the length of the adjustment sleeve 3 engaged in the support 2a, the counter-groove 5 provides an adjustment reference and its angular position around the axis A remains constant. To achieve this, the counter-groove 5 has in this example two ears 5b which each fit into a bay 5c machined in the support 2a. The contact between the ears 5b and the bays 5c is made in a plane adapted to block the rotation of the counter-groove 5 relative to the support 2a.

Alternatively, to the spring, any return means such as a leaf spring, a magnetic, electrical or pneumatic system can be used to hold the grooved washer in the counter groove. In addition, non-radial groove geometries, pins and generally any geometry allowing the grooved washer to fit into the counter groove can be used.

Also, the translational locking of the sleeve relative to the rod can be achieved by any locking means, such as by welding or with a locking pin.

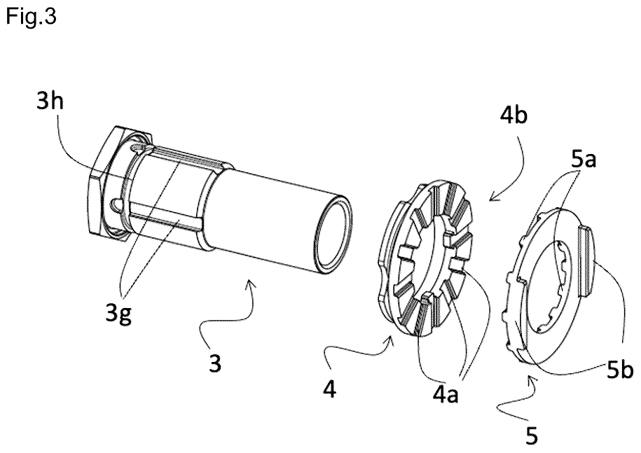

The exploded views of FIG. 2, which is a simplified view of FIG. 1, and FIG. 3 show the adjusting sleeve 3, the grooved washer 4 and the counter groove 5.

The Support 2a with the rod 2b is also visible in FIG. 2.

In these FIGS. 2 and 3, the cylindrical body 3a of the adjustment sleeve 3 is detailed. This cylindrical body 3a comprises an adjustment end 3b, an intermediate section 3e with grooves and a distal section 3f with an external thread 3d. In this embodiment, the adjustment sleeve 3 is made of metallic material, axial grooves 3g and a circumferential groove 3h being machined in the intermediate section 3e. The grooved washer 4 and the counter groove 5 are also made of metallic materials. Alternatively for applications other than locking aircraft door fasteners, these parts can be molded in plastic or made from composite materials.

The grooved washer 4 has two faces:
a face 4b with the grooves 4a facing the face 5d of the counter-groove 5, this face 5b carrying the radial moldings 5a geometrically complementary to the grooves 4a, and a face 4c forming a support surface 4d of the compression spring 6 and comprising a traction collar 4e.

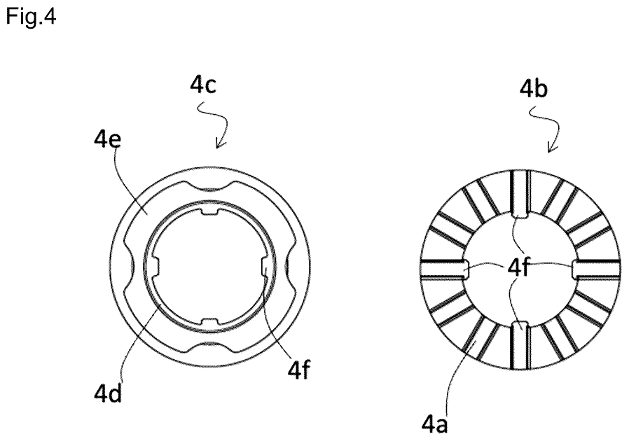

Further, FIG. 4 shows views of faces 4b and 4c of grooved washer 4. Face 4c includes in particular the traction collar 4e which allows the grooved washer 4 to be pulled to separate it from the counter-groove 5. Some streaks of the face 4b extend towards the center of the grooved washer 4 and form four internal protrusions 4f which guide the grooved washer 4 in translation along the adjustment sleeve 3. Alternatively, the number of protrusions and the geometry of the collar can vary depending on the level of stress placed on the grooved washer.

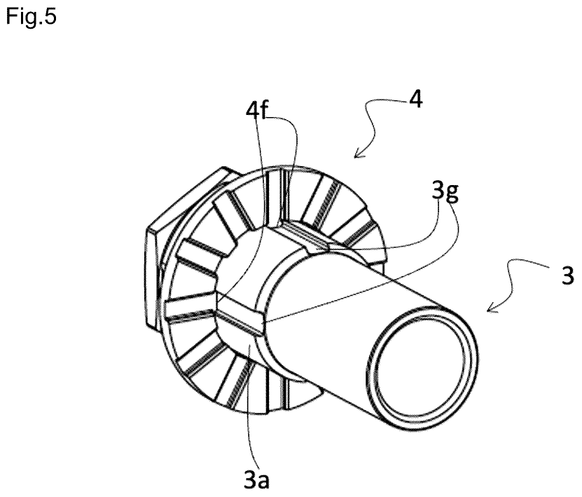

The adjusting sleeve 3 positioned in the grooved washer 4 is shown in FIG. 5. In this figure, it appears that the body 3a of the adjustment sleeve 3 has four axial grooves 3g along its axis, an internal protrusion 4f of the grooved washer 4 being inserted into each of these axial grooves 3g. This assembly then makes this washer able to move in translation along the adjustment sleeve 3. In addition, these internal protrusions 4f block the rotation of the grooved washer 4 relative to the adjustment sleeve 3.

FIG. 6a and FIG. 6b illustrate a perspective and sectional view respectively of the secure adjustment locking device in the locking position. In this position, the grooved washer 4 is fitted and engaged in the counter groove 5. The grooved washer 4 is also rotationally integral with respect to the adjustment sleeve 3 and secured by the thrust of the compression spring 6 which bears on the one hand in the hollow 3i of the head 3c of the adjustment sleeve 3 and on the other hand against the face 4c of the grooved washer 4. The counter-groove 5 is also embedded in the support 2a by the ears 5b which fit into the support 2a and block the rotation of the counter-groove 5.

In FIG. 6b, the connection between the external thread 3d of the adjustment sleeve 3 and the internal thread 2g of the support 2a is shown. This connection makes it possible to adjust the attachment 2 by converting the rotation of the head 3c of the adjustment sleeve 3 into translation of this sleeve in the attachment 2. This translation adjusts and sets the position of the rod 2b in the attachment 2.

The section in FIG. 6b, which is made at the level of the axial grooves 3g and the internal protrusions 4f, shows that the grooved washer 4 is movable along the adjustment sleeve 3 by sliding of the internal protrusions 4f in the axial grooves 3g between the locking position and a released position. In this released position, the grooved washer 4 is immobilized at a distance “d” from the counter-groove 5, this distance being sufficient to avoid contact between the grooved washer 4 and the counter-groove 5 while allowing rotation of the adjustment sleeve 3 relative to the support 2a. In addition, at this distance “d” is positioned the circumferential groove 3h which is adapted to receive the internal protrusions 4f.

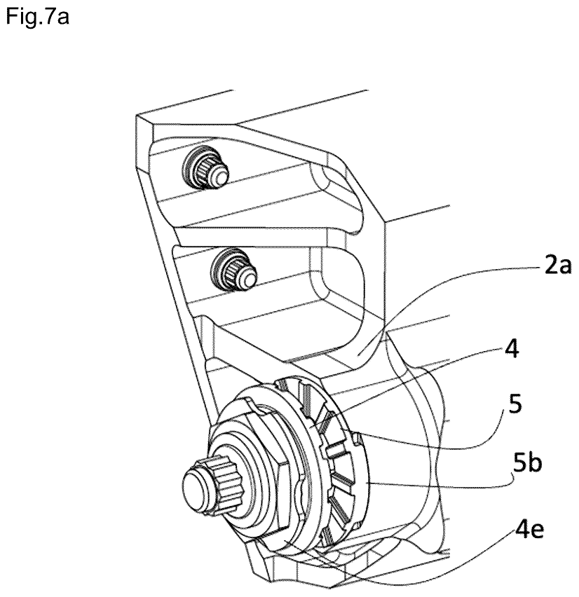

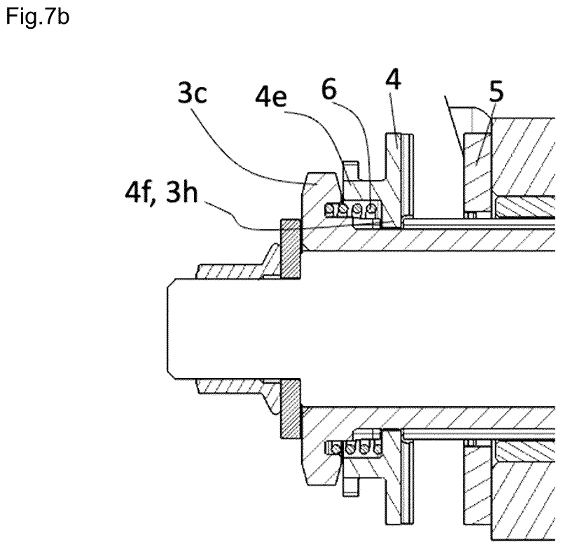

FIG. 7a and FIG. 7b show a perspective and sectional view respectively of the secure adjustment locking device when the grooved washer 4 is at the end of its translation along the axial grooves 3g. The traction collar 4e abuts on the head 3c of the adjustment sleeve 3 and the internal protrusions 4f enter the circumferential groove 3h.

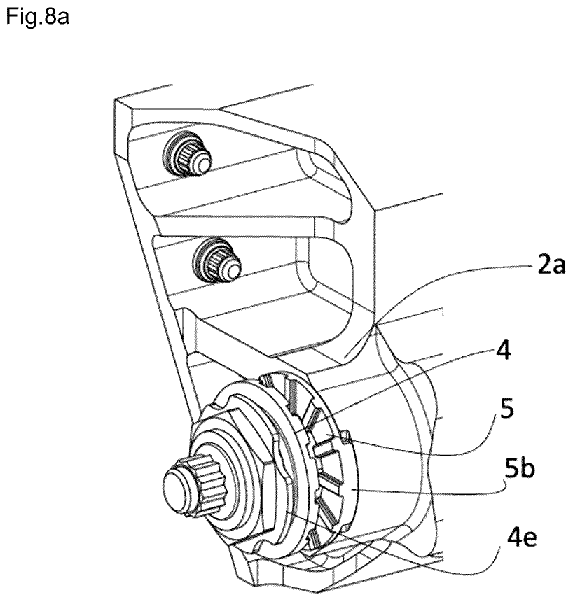

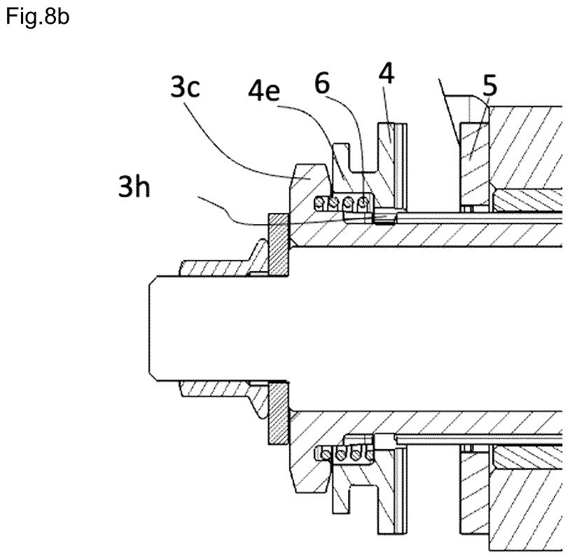

The grooved washer 4 can then pivot relative to the adjustment sleeve 3 by sliding and engaging the internal protrusions 4f in the circumferential groove 3h, as illustrated in FIG. 8a and FIG. 8b. The internal protrusions 4f are therefore no longer in the axial grooves 3g and the grooved washer 4 can no longer move along the adjustment sleeve 3. The grooved washer 4 is then held in the circumferential groove 3h by the combined action of the compression spring 6, which pushes the grooved washer 4 towards the counter-groove 5, and the internal protrusions 4f which are in abutment in the circumferential groove 3h.

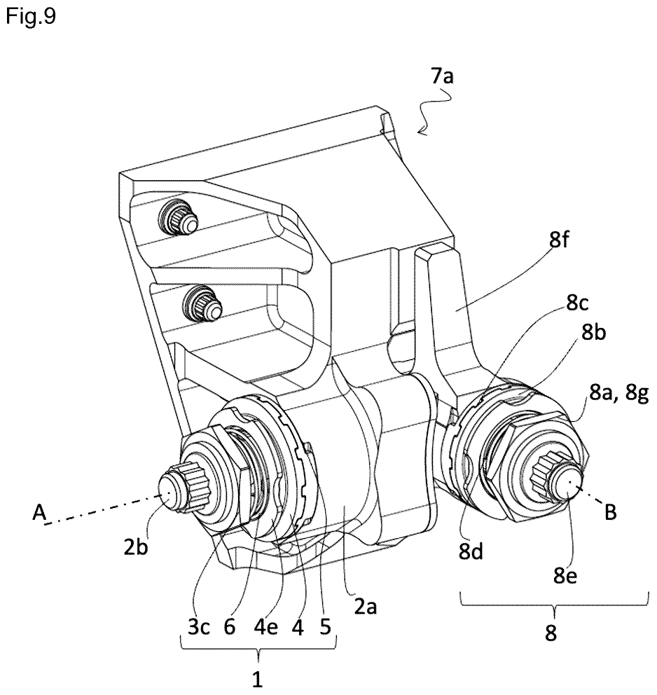

FIG. 9 shows an attachment 7a which has two adjustment means along two axes A and B perpendicular to each other. Each of these adjustment means is equipped, along axis A, with the secure locking device 1 described above and, along axis B, with the secure locking device 8. This device also includes an adjusting sleeve 8a with an adjusting end 8g, a grooved washer 8b, a counter groove 8c, a compression spring 8d, a rod 8e and a support 8f.

The operation of the secure locking devices 1 and 8 is similar: the grooved washer 8b is movable between a locking position and a released position. The adjustment in the direction of the axis B is carried out relative to the support 8f which is integral with the adjustment rod 2b in the direction of the axis A. Advantageously, this combination of the support 8f with the rod 2b makes it possible to carry out and simplify the adjustments in the directions of the axes A and B by limiting the number of parts used, by bringing these parts together on the same attachment and by using the same adjustment principle. FIG. 10 illustrates a mechanical opening/closing system 7 of an aircraft door comprising an arm 7c connected to the door frame 7d by two attachments 7a and 7b. These attachments 7a and 7b are similar and allow adjustments in the same two perpendicular directions along axes A and B.

This preferred combination simplifies the adjustments and provides access to other adjustment settings. Indeed, each attachment 7a, 7b used individually makes it possible to move the arm 7c in translation in the direction of axis A or the direction of axis B.

However, an aircraft door has a significant mass and two attachments are commonly used to support its weight. When both attachments 7a and 7b are used together, the translational movement of the arm 7c in the direction of axis A or axis B is simplified by applying the same adjustment setting to each of the attachments. Additionally, additional rotational adjustment possibilities are accessible by applying different settings to each attachment 7a, 7b. Alternatively, if the adjustment axes of the attachments 7a and 7b are different, all the adjustments of the arm 7c in translation and rotation are still possible, and made by iteration steps.

The installation of a door on a frame 7d with a mechanical opening/closing system 7 which includes four secure locking devices as described above, takes place according to the following steps:
attaching the mechanical opening/closing system 7 of the door on the frame 7d;
initial positioning of the door in the frame 7d;
assembling of the door on the mechanical opening/closing system 7, and
adjusting of the attachments 7a and 7b.

Each adjustment of the attachments 7a and 7b then takes place according to the following steps:
disengagement of the grooved washer from the counter groove;
holding the grooved washer in the unlocked position;
adjustment of the attachment by operating the adjustment end;
release of the grooved washer, and
checking the engagement of the grooved washer in the counter groove.

In an example implementation:
the step of disengaging the grooved washer from the counter groove is carried out by a translation of the grooved washer in the axial groove in opposition to the direction of action of the compression spring;
the step of holding the grooved washer in the released position is carried out by rotating the grooved washer in the circumferential groove of the adjustment sleeve, and
the grooved washer release step is carried out by reverse rotation of the grooved washer in the circumferential groove of the adjustment sleeve until the internal protrusions are positioned at the entrance to the axial grooves.

Alternatively, the axial groove can be helical and the grooved washer follows helical kinematics instead of translation.

Alternatively, holding the grooved washer in the unlocked position can be achieved by any locking means such as a stop pin or a hook.

The secure adjustment lock is implemented by the combination of two rotation locks:
a first blockage between the moldings of the counter-groove and the grooves of the grooved washer, and
a second lock between the internal protrusions of the grooved washer and the axial grooves of the adjustment sleeve.

Alternatively, any other rotation locking means mentioned above can also be used between the counter-groove and the grooved washer, as well as between the grooved washer and the adjustment sleeve.

1. attachment (2, 7a, 7b) with an adjustment system (1) for an opening panel and a secure locking device for the adjustment system (1), the attachment (2, 7a, 7b) being adapted to be connected to a frame (7d) by a support (2a) of said attachment (2, 7a, 7b) and comprising at least one rod (2b), each rod (2b) being inserted into an adjustment sleeve (3) and secured to the adjustment sleeve (3) by a translational locking device, each adjustment sleeve (3) having:
a cylindrical body (3a) with an external thread (3d) facing an internal thread (2g) of the support (2a), and
a rotating adjustment end (3b);
wherein the secure locking device (1) comprises a grooved washer (4) in translation along each adjustment sleeve (3) as well as a return device which is connected to the adjustment end (3b) and which keeps the grooved washer (4) in contact with a counter-groove (5) integral with the attachment support and of complementary configuration to the grooved washer (4), the washer being movable between:
a secure locking position in which the grooved washer (4) is engaged in the counter-groove (5), rotationally secured relative to the adjustment sleeve (3) and secured by a push of the return means, and
a released position which immobilizes the grooved washer (4) at a distance d from the counter-groove (5).

2. The attachment (2, 7a, 7b) with the secure locking device (1) according to claim 1, wherein the return device is a compression spring (6) place against the adjustment end (3b) of the adjustment sleeve (3).

3. The attachment (2, 7a, 7b) with the secure locking device (1) according to claim 2, wherein the grooved washer (4) comprises a bearing surface (4d) of the compression spring (6)

4. The attachment (2, 7a, 7b) with the secure locking device (1) according to claim 3, wherein the bearing surface (4d) of the grooved washer (4) comprises a traction collar (4e).

5. The attachment (2, 7a, 7b) with the secure locking device (1) according to claim 1, wherein the grooved washer (4) comprises at least one internal protrusion (4f).

6. The attachment (2, 7a, 7b) with the secure locking device (1) according to claim 5, wherein in the cylindrical body (3a) of the adjustment sleeve (3) comprises at least one axial groove (3g) in which is inserted one internal protrusion (4f) of the grooved washer (4) which is able to move in translation along the cylindrical body (3a).

7. The attachment (2, 7a, 7b) with the secure locking device (1) according to claim 5, wherein the cylindrical body (3e) of the adjustment sleeve (3) comprises a circumferential groove (3h) positioned at least at the distance d from the counter-groove (5) and adapted to receive the internal protrusions (4f) of the grooved washer (4).

8. The attachment (2, 7a, 7b) the secure locking device (1) according to claim 1, wherein the grooved washer (4) and the counter groove (5) are made of metallic material.

9. The attachment (2, 7a, 7b) with the secure locking device (1) according to claim 1, wherein the grooved washer (4) has radial grooves which fit onto the counter groove (5).

10. An attachment (7a, 7b) comprising an adjustment device along two axes A and B perpendicular to each other, wherein each one of the adjustment devices is equipped with a secure locking device (1) according claim 1.

11. A mechanical opening/closing system (7) of an opening panel comprising: an arm (7c) and a frame (7d) and is connected to the frame (7d) by two attachments (7a, 7b) according to claim 10.

12. A method for installing an opening panel in the frame (7d) with a mechanical opening/closing system (7) according to claim 11, further comprising at least one secure adjustment locking device produced according to the following steps:
attaching the mechanical opening/closing system (7) of the opening on the frame (7d);
initial positioning of the opening in the frame (7d);
assembling the opening panel on the mechanical opening/closing system (7), and
adjusting of the attachments (7a, 7b)
wherein the adjustment of the attachments (7a, 7b) takes place according to the following steps:
disengagement of the grooved washer (4, 8b) from the counter-groove (5, 8c);
holding the grooved washer (4, 8b) in the unlocked position;
adjustment of the attachment (7a, 7b) by operating the adjustment end (3b, 8g);
release of the grooved washer (4, 8b), and checking the engagement of the grooved washer (4, 8b) in the counter groove (5, 8c).

13. The method according to claim 12, wherein the step of disengaging the grooved washer (4, 8b) from the counter-groove (5, 8c) is carried out by a translation of the grooved washer (4, 8b) in the axial groove (3g) in opposition to the return device.

14. The method according to claim 12, wherein the step of holding the grooved washer (4, 8b) in the released position is carried out by rotating the grooved washer (4, 8b) in the circumferential groove (3h) of the adjustment sleeve (3).

15. The method according to claim 12, wherein the step of releasing the grooved washer (4, 8b) is carried out by a reverse rotation of the grooved washer (4, 8b) in the circumferential groove (3h) of the adjustment sleeve.
